(19) United States
(12) Patent Application Publication
(10) Pub. No.: US 2016/0358196 A1
(43) Pub. Date: Dec. 8, 2016

(54) INFORMATION PROCESSOR, INFORMATION PROCESSING METHOD, AND COMPUTER-READABLE STORAGE MEDIUM

(71) Applicant: CASIO COMPUTER CO., LTD., Tokyo (JP)

(72) Inventor: Taiga MURAYAMA, Tokyo (JP)

(73) Assignee: CASIO COMPUTER CO., LTD., Tokyo (JP)

(21) Appl. No.: 15/136,222

(22) Filed: Apr. 22, 2016

(30) Foreign Application Priority Data
Jun. 8, 2015 (JP) 2015-115448

(51) Int. Cl. G06Q 30/02

(52) U.S. Cl. CPC G06Q 30/0222

(57) ABSTRACT

An information processor includes: a recognition section that recognizes a customer; an average payment amount obtaining section that obtains an average payment amount of the recognized customer; and a free-gift information determination section that determines free-gift information based on the average payment amount.

### CROSS-REFERENCE TO RELATED APPLICATION

This application is based upon and claims the benefit of priority under 35 USC 119 of Japanese Patent Application No. 2015-115448 filed on Jun. 8, 2015, the entire contents of which are incorporated herein by reference.

### BACKGROUND OF THE INVENTION

The present invention relates to an information processor, an information processing method, and a computer-readable storage medium.

A conventional coupon issuing device issues a coupon when the number of purchases of a customer reaches a predetermined number. The conventional coupon issuing device, however, issues a coupon only based on the number of purchases, and does not consider an average payment amount of the customer (see, for example, Japanese Unexamined Patent Publication No. 2014-52816).

### SUMMARY OF THE INVENTION

The present invention has been made in view of problems of conventional techniques, and provides an information processor, an information processing method, and a computer-readable storage medium that can determine free-gift information based on an average payment amount.

An information processor includes: a recognition section that recognizes a customer; an average payment amount obtaining section that obtains an average payment amount of the recognized customer; and a free-gift information determination section that determines free-gift information based on the average payment amount.

According to the present invention, free-gift information can be determined based on an average payment amount.

### BRIEF DESCRIPTION OF THE SEVERAL VIEWS OF THE DRAWING

FIG. 1 illustrates a configuration of a coupon issuing system according to an embodiment of the present invention.

FIG. 2 is a block diagram of a POS register according to the embodiment.

FIG. 3 is a block diagram of a mobile terminal according to the embodiment.

FIG. 4 is a flowchart of a POS register according to a first embodiment of the present invention.

FIG. 5 is a flowchart of a mobile terminal according to the first embodiment.

FIG. 6 is a flowchart of a POS register according to a second embodiment of the present invention.

FIG. 7 is a flowchart of a mobile terminal according to the second embodiment.

### DETAILED DESCRIPTION OF THE INVENTION

Embodiments of the present invention will be described hereinafter with reference to the drawings.

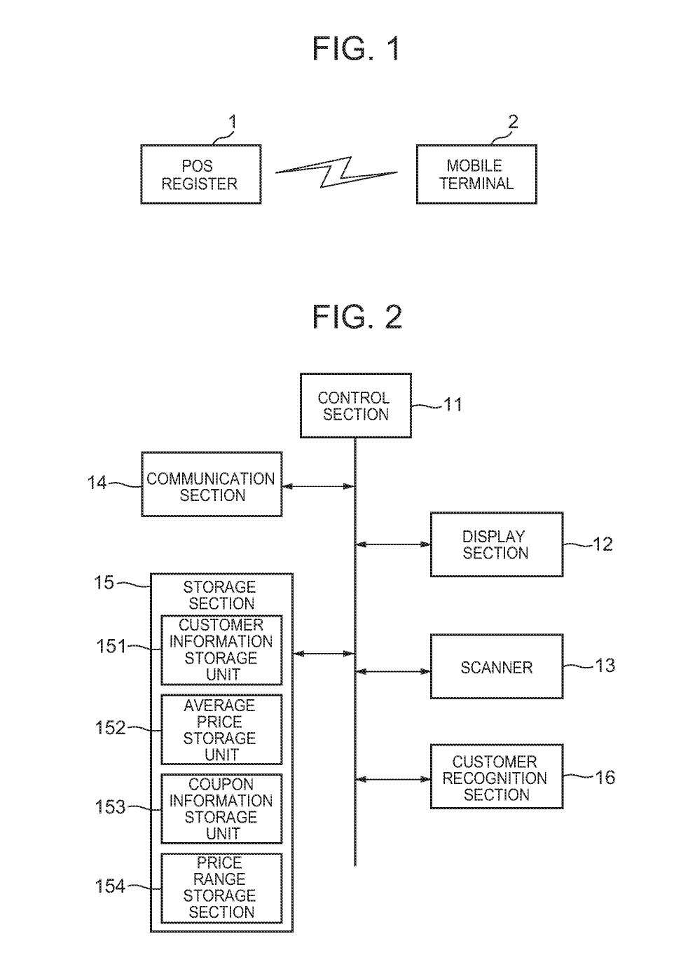

FIG. 1 illustrates a configuration of a coupon issuing system according to an embodiment of the present invention. The coupon issuing system according to the present embodiment includes a POS register 1 and a mobile terminal 2 that communicates with the POS register 1 wirelessly. The POS register 1 and the mobile terminal 2 communicate with each other wirelessly based on Bluetooth (registered trademark) low energy (hereinafter referred to as BLE). The BLE is a standard (mode) developed in order to reduce power consumption in a near-field wireless communication standard called Bluetooth (registered trademark).

As illustrated in FIG. 2, the POS register 1 includes a control section 11, a display section 12, a scanner 13, a communication section 14, and a storage section 15. The storage section 15 includes a customer information storage unit 151, an average price storage unit 152, and a coupon information storage unit 153.

The control section 11 is constituted by, for example, a central processing unit (CPU), and includes a CPU that executes programs stored in the storage section 15 to perform a predetermined computation and control the other sections and a memory that serves as a work area in executing programs (both not shown).

The display section 12 is constituted by, for example, a liquid crystal display, and displays information transmitted from the control section 11. The scanner 13 scans bar codes of products and transmits a result of scanning to the control section 11.

The communication section 14 transmits and receives radio signals based on BLE through an unillustrated antenna, and transmits coupon information to the mobile terminal 2. The storage section 15 includes the customer information storage unit 151 that stores membership information on customers and grades of the customers, the average price storage unit 152 that stores average prices of products purchased by customers, and the coupon information storage unit 153 that stores coupon information.

The customer recognition section 16 includes a card reader (not shown) that reads a membership card of a customer and recognizes the customer based on the read-out membership card.

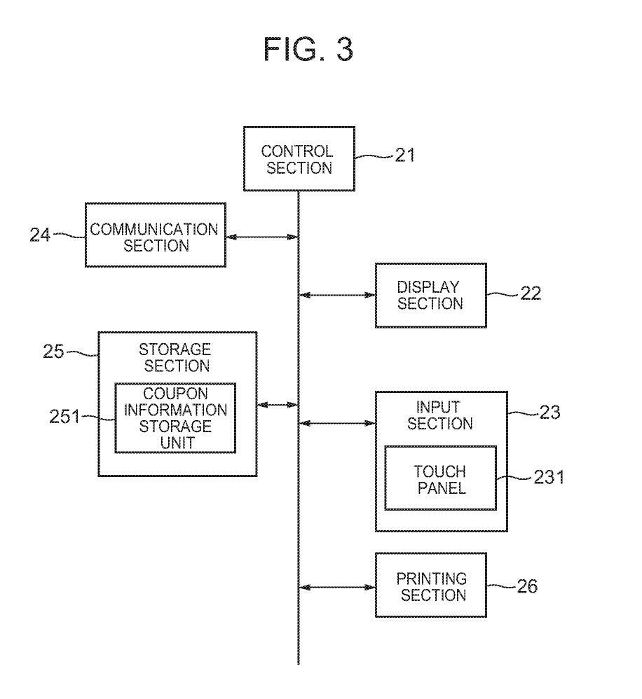

FIG. 3 is a block diagram illustrating a configuration of the mobile terminal 2. The mobile terminal 2 includes a control section 21, a display section 22, an input section 23, a communication section 24, a storage section 25, and a printing section 26. The input section 23 includes a touch panel 231. The storage section 25 includes a coupon information storage unit 251.

The control section 21 is constituted by, for example, a central processing unit (CPU) and includes a CPU that executes programs stored in the storage section 25 to perform a predetermined computation and control the other sections and a memory that serves as a work area in executing programs (both not shown).

The display section 22 is constituted by, for example, a liquid crystal display (LCD) or an electroluminescence (EL) display.

The input section 23 is an interface including the touch panel 231, disposed in an upper surface of the display section 21, and used for inputting the type of an operation by a user. The touch panel 231 incorporates, for example, an unillustrated transparent electrode, and when a finger of a user contacts the touch panel 231, detects a position where a voltage changes as a contact position and outputs information on this contact position to the control section 21 as an input instruction. In the present embodiment, the touch panel 231 is used for a scratch process for erasing a scratch image displayed on the display section 22 based on the detected contact position.

The communication section 24 transmits and receives a radio signal based on BLE through an unillustrated antenna, and receives coupon information from the POS register 1.

The storage section 25 includes the coupon information storage unit 251. The coupon information storage unit 251 stores coupon information received by the communication section 24. The printing section 26 prints coupon information displayed after a scratch process described later.

### First Embodiment

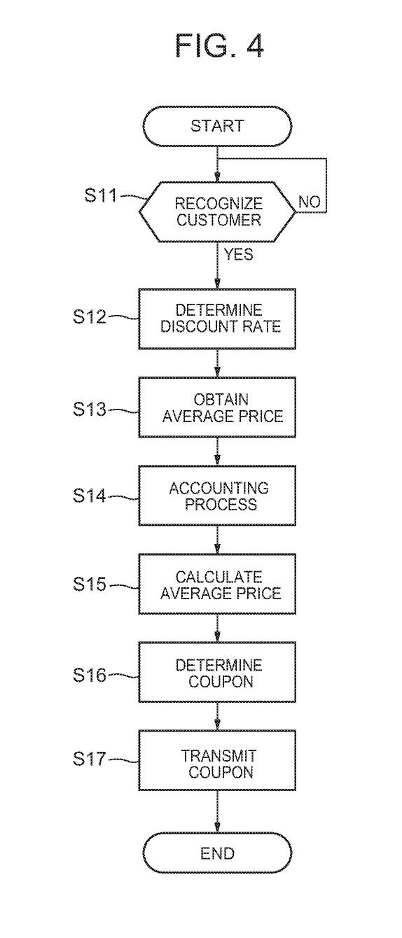

FIG. 4 is a flowchart showing a coupon issuing process of the POS register 1 according to the first embodiment.

First, the POS register 1 determines whether the customer recognition section 16 recognizes a customer based on a membership card of the customer (step S11). If the customer recognition section 16 does not recognize the customer (No in step S11), step S11 is repeated.

If the customer recognition section 16 recognizes the customer (Yes in step S11), the control section 11 refers to the customer information storage unit 151 and determines a discount rate based on a grade of the customer (step S12). For example, in a case where the recognized customer makes two or more purchases weekly, the customer is defined as a premium member so that the customer has a discount rate of 20%. In a case where the recognized customer makes one purchase monthly, the customer has a discount rate of 5%.

Then, an average price of the recognized customer is obtained from the average price storage unit 152 (step S13).

After step S13, an accounting process is performed with the scanner 13 (step S14), and an average price of the customer is calculated based on a result of the accounting process and the obtained average price (step S15).

Based on the discount rate determined in step S12 and the calculated average price, the type of a coupon is determined (step S16). For example, in a case where the discount rate is 20% and the average price is X yen (Japanese yen), the control section 11 refers to a price range storage section 154 and selects a coupon for a product whose price after 20% discount is in the same price range as X yen.

After the coupon is selected, the POS register 1 transmits coupon information based on the selected coupon to the mobile terminal 2 using the communication section 14.

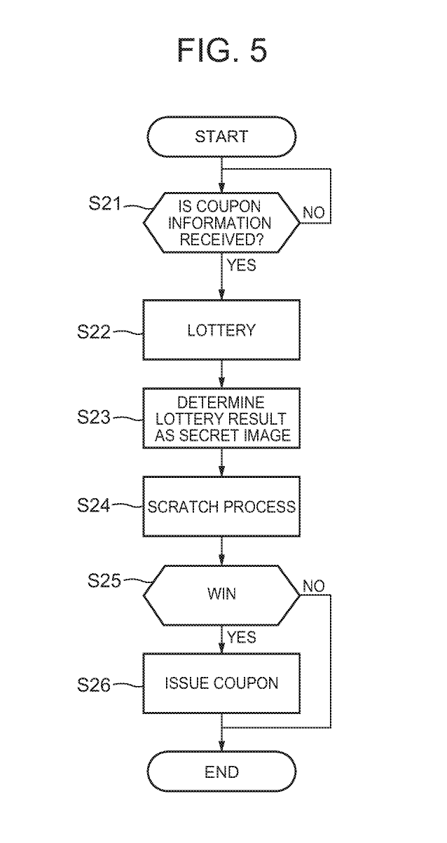

FIG. 5 is a flowchart showing a coupon issuing process of the mobile terminal 2 according to the first embodiment.

First, the mobile terminal 2 determines whether coupon information is received from the POS register 1 or not (step S21). If coupon information is not received (No in step S21), step S21 is repeated until coupon information is received.

If coupon information is received (Yes in step S21), a lottery process is performed (step S22). In the lottery process, a random number of 0 to 1 is generated. If the random number is greater than or equal to 0.8, the customer wins, and otherwise, the customer loses.

The result of the lottery in step S22 is determined as a secret image for scratching (step S23), and a scratch image is displayed. The scratch image is a secret image concealed with an image that is to be erased by a scratch process described later.

After the scratch image is displayed, the scratch process is performed (step S24). The scratch process is a process in which the user uses the touch panel 231 for a scratch image displayed on the display section 22 and specifies a position so that an image at the specified position is erased and a secret image at this position is displayed.

After all the secret images are displayed in the scratch process, it is determined whether the lottery result in step 22 is winning or not (step S25). If the customer loses (No in step S25), the coupon issuing process is finished.

If the lottery result is winning (Yes in step S25), a coupon is issued from the printing section 26 (step S26).

As described above, in the first embodiment, coupon information can be changed based on an average price.

### Second Embodiment

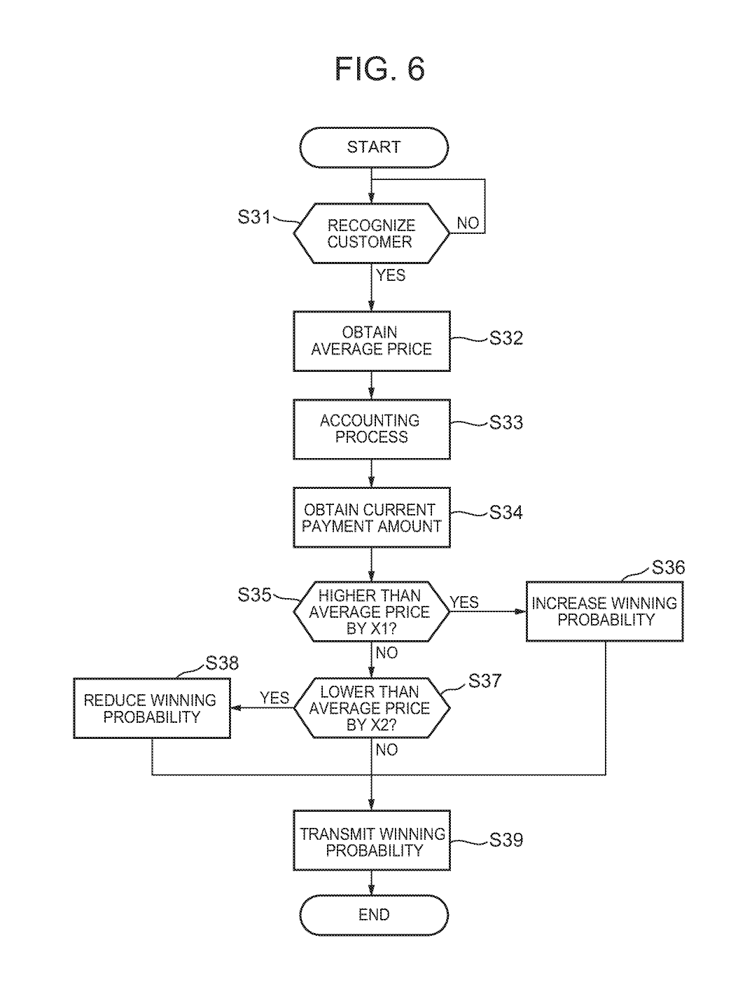

FIG. 6 is a flowchart of a coupon issuing process of a POS register 1 according to a second embodiment.

First, the POS register 1 determines whether a customer recognition section 16 recognizes a customer based on a membership card of the customer (step S31). If the customer recognition section 16 does not recognize the customer (No in step S31), step S31 is repeated.

If the customer recognition section 16 recognizes the customer (step S31), an average price of the recognized customer is obtained from the average price storage unit 152 (step S32).

Then, an accounting process is performed (step S33). After the accounting process, a current payment amount is obtained (step S34).

Then, it is determined whether the current payment amount obtained in step S34 is higher than the average price obtained in step 32 by X1 (step S35). If the current payment amount is higher than the average price by X1 (Yes in step S35), the winning probability is increased (step S36), and the process proceeds to step S39. For example, suppose the lottery process of the mobile terminal 2 is similar to that in the first embodiment, the customer wins if the random number is greater than or equal to 0.8 in general. In a case where the winning probability is increased in step S36, the customer wins if the generated random number is greater than or equal to 0.7, and 0.7 is stored as winning probability information.

If it is not determined that the current payment amount is higher than the average price by X1 in step S35 (No in step S35), the process proceeds to step S37, and the current payment amount is determined to be lower than the average price by X2 (step S37).

If it is determined that the current payment amount is lower than the average price by X2 in step S37 (Yes in step S37), the winning probability is reduced (step S38), and the process proceeds to step S39. For example, in the case where the winning probability is reduced, the customer wins if the generated random number is greater than or equal to 0.9, and 0.9 is stored as winning probability information.

If it is not determined that the current payment amount is lower than the average price by X2 in step S37 (No in step S37), the process proceeds to step S39.

In step S39, the communication section 14 transmits winning probability information determined based on the average price and the current payment amount to the mobile terminal 2. If the winning probability is neither increased nor reduced, 0.8 is transmitted to the mobile terminal 2 as winning probability information.

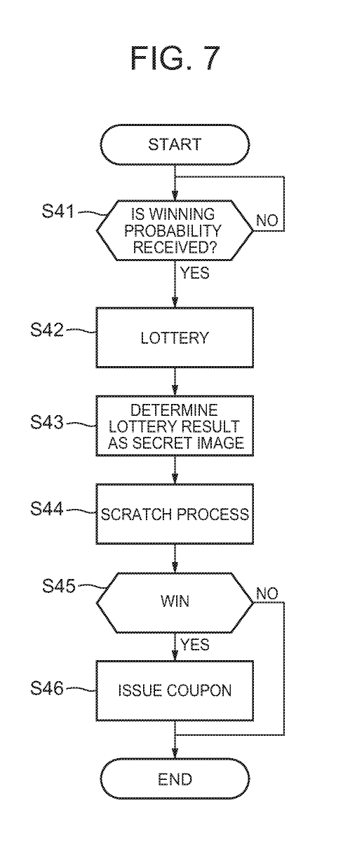

FIG. 7 is a flowchart showing a coupon issuing process of a mobile terminal 2 according to the second embodiment.

First, the mobile terminal 2 determines whether winning probability information is received from the POS register 1 or not (step S41). If it is determined that no coupon information is received (No in step S41), step S41 is repeated until coupon information is received.

If it is determined that coupon information is received (Yes in step S41), a lottery process is performed (step S42). In the lottery process, a random number of 0 to 1 is generated. If the random number is larger than the received winning probability information, the customer wins, and otherwise, the customer loses.

The result of the lottery in step S42 is included in a secret image for scratching (step S43), and a scratch image is displayed. The scratch image is a secret mage concealed with an image that is to be erased by a scratch process described later.

After the scratch image is displayed, the scratch process is performed (step S44). The scratch process is a process in which the user uses the touch panel 231 for a scratch image displayed on the display section 22 and specifies a position so that an image at the specified position is erased and a secret image at this position is displayed.

After all the secret images are displayed in the scratch process, it is determined whether the lottery result in step 42 is winning or not (step S45). If the customer loses (No in step S45), the coupon issuing process is finished.

If the lottery result is winning (Yes in step S45), a coupon is issued from the printing section 26 (step S46).

As described above, in the second embodiment, the winning probability can be changed based on the average price and the current payment amount of a customer.

In the first embodiment, the coupon information is changed, whereas the winning probability is changed in the second embodiment. However, the present invention is not limited to these examples, and free-gift information may be changed.

In the first and second embodiments, the printing section 26 is provided in the mobile terminal 2 to obtain a coupon. However, the present invention is not limited to this example, and a coupon may be obtained by the communication section 24.

Although preferred embodiments of the present invention have been described, the present invention is not limited to the specific embodiments, and may include the scope and its equivalent range as defined by the appended claims.

What is claimed is:

1. An information processor comprising:
a recognition section that recognizes a customer;
an average payment amount obtaining section that obtains an average payment amount of the recognized customer; and
a free-gift information determination section that determines free-gift information based on the average payment amount.

2. The information processor of claim 1, wherein
the free-gift information determination section determines the free-gift information based on a discount rate and the average payment amount.

3. The information processor of claim 1, further comprising
a price range storage section that stores a price range of an average price, wherein
the free-gift information is a coupon which discounts a product price, and
the free-gift information determination section determines the coupon in such a manner that the price range of the discounted product price by the coupon is equal to the price range of the average price.

4. The information processor of claim 2, further comprising
a price range storage section that stores a price range of an average price, wherein
the free-gift information is a coupon which discounts a product price, and
the free-gift information determination section determines the coupon in such a manner that the price range of the discounted product price by the coupon is equal to the price range of the average price.

5. The information processor of claim 1, wherein
the average payment amount is an average price of products purchased by the customer.

6. The information processor of claim 2, wherein
the average payment amount is an average price of products purchased by the customer.

7. The information processor of claim 3, wherein
the average payment amount is an average price of products purchased by the customer.

8. The information processor of claim 4, wherein
the average payment amount is an average price of products purchased by the customer.

9. The information processor of claim 1, further comprising:
a current payment amount obtaining section that obtains a current payment amount of the customer; and
a comparison section that compares the current payment amount with an average payment amount, wherein
the free-gift information determination section determines free-gift information based on a comparison result by the comparison section.

10. The information processor of claim 1, wherein
the free-gift information is a probability of winning a free-gift.

11. The information processor of claim 9, wherein
the free-gift information is a probability of winning a free-gift.

12. An information processing method using an information processor, the method comprising:
a recognition step of recognizing a customer;
an average payment amount obtaining step of obtaining an average payment amount of the recognized customer; and
a free-gift information determination step of determining free-gift information based on the average payment amount.

13. A computer-readable storage medium storing a program including a series of instruction to be executed by a computer included in an information processor, the medium comprising:
a recognition section that recognizes a customer;
an average payment amount obtaining section that obtains an average payment amount of the recognized customer; and
a free-gift information determination section that determines free-gift information based on the average payment amount.
